(19) United States
(12) Patent Application Publication
(10) Pub. No.: US 2009/0264569 A1
(43) Pub. Date: Oct. 22, 2009

(54) PHENOLIC RESIN PRODUCT AND METHOD OF MANUFACTURING A PHENOLIC RESIN PRODUCT

(76) Inventor: David Gavin Rogers, Queensland (AU)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/375,833

(22) PCT Filed: Jul. 31, 2007
(86) PCT No.: PCT/AU2007/001069

§ 371 Date: May 7, 2009

(30) Foreign Application Priority Data
Jul. 31, 2006 (AU) 2006904120

(51) Int. Cl. C08K 5/053

(52) U.S. Cl. 524/386

(57) ABSTRACT

A composition comprising a phenolic resin and crude glycerol is provided. The composition is suitable for use in producing a phenolic resin product. A method of producing a phenolic resin product including the step of adding crude glycerol to a phenolic resin to thereby produce the phenolic resin product is also provided. Also provided is a phenolic resin product produced by the method and a phenolic resin product comprising a phenolic resin modified by adding crude glycerol. Articles produced from the products have improved physical properties and are particularly useful in manufacturing civil engineering and building materials. The crude glycerol in the composition may be no more than 80% pure.

### FIELD OF THE INVENTION

The present invention relates to phenolic resins In particular, but not exclusively, the present invention relates to a phenolic resin product that comprises a crude additive and a method of manufacturing the phenolic resin product. The phenolic resin is suitable for use in civil engineering and/or building products.

### BACKGROUND TO THE INVENTION

For several years it has been apparent that fibre composites have significant potential for application in civil engineering and the building industry. Over the past decade there has been a concerted effort by the international composites community to migrate composite materials technology from traditional markets such as aerospace and marine into these new areas of application. However, the uptake of these materials continues to be slow and while a number of large scale projects have now been constructed around the world, this type of application remains the exception rather than the rule.

Two issues which have been identified as major impediments to the broader utilization of fibre composites in civil engineering and the building industry are the high cost and lack of fire resistance of composite structures. Standard resins such as polyesters, vinylesters and epoxies have generally good mechanical strength but are expensive. Another serious defect of these resins is that they are easily combustible. Because of this defect it is difficult to use these materials in interior applications or fire prone areas.

One type of resin that has excellent flame retardancy and low smoke characteristics is phenolic resin. Phenolic resins, such as bakelite and other related space-network polymers, are obtained by a step-reaction polymerization of phenol and formaldehyde in the presence of a catalyst to produce a rigid three-dimensional structure. This resin is one of the cheaper resins but it exhibits brittleness and poor impact resistance which is a major drawback in many composite applications.

A range of techniques to improve the structural performance of phenolic resins have been investigated over the years. However, most of these have resulted in a significant increase in the cost of the phenolic resin.

The efforts aimed at improving the flexibility and toughness of phenolic resins can be classified in two categories; non-reactive approaches and chemical modification.

Non-reactive approaches involve the addition of flexible fillers such as rubber particles to the phenolic resin. A drawback of the non-reactive approaches is that they generally result in a significant increase in resin viscosity and cost. These drawbacks limit the applicability of this approach.

Chemical modification can be achieved two different ways. One way is to introduce flexible polymer segments into the phenolic backbone structure during the preparation of the phenolic resin. Candidate polymer modifiers include isocyanates, polyvinyl alcohol, resorcinol and various polyols. This approach requires chemical companies to change their resin production process which is very expensive and therefore will generally only be implemented if there is an existing large market for this customized product.

The second chemical modification approach is based on adding a second polymer, additive or modifier that is compatible with standard phenolic resin and capable of being cured along with the resin on-site. This approach is easier and less expensive to realise as it does not require changes to the established large scale chemical production process of phenolic resins.

Typical modifiers used in the chemical modification approaches are industrial grades of ethylene glycol, di-ethylene glycol, polyethylene glycol, polypropylene glycol, glycerol, polyvinyl acetates and polyvinyl butyral. These modifiers are typically employed in amounts from about 5-25 weight percent based on the resin. These modifiers can be incorporated during the preparation of the phenolic resin by the manufacturer and delivered as a final product or added as reactive modifiers during processing of the resin on-site, such as at the factory floor.

Conventionally, to avoid the physical properties of the phenolic resin being adversely affecting by impurities purified or industrial grade modifiers are used. For example, in the case of using glycerol as a modifier, the glycerol must be refined using expensive processes, such as, vacuum distillation and ion exchange, to have a purity in the range of 99.5 to 99.7%.

A serious drawback of this chemical modification approach is that the modifiers are generally more expensive than the phenolic resin itself, resulting in a significant price increase of the final product. This cost penalty has limited the widespread use of this chemical modification approach to date. The major reason for the high cost of most chemical modifiers is that they are derived from petrochemical feed stocks. Due to recent rises in the cost of petrochemicals these products have become even more expensive.

### OBJECT OF THE INVENTION

It is an object of the invention to provide a phenolic resin product and/or a method of producing a phenolic resin product. A preferred object is to provide a phenolic resin that has improved flexibility and/or impact resistance. Another preferred object is to provide a phenolic resin that is relatively cost effective to produce.

It is an also an object of this invention to overcome or alleviate one or more of the above disadvantages of the prior art and/or provide the consumer with a useful or commercial choice.

Further objects will be evident from the following description.

### SUMMARY OF THE INVENTION

The present invention is broadly directed to providing a phenolic resin product that comprises a crude chemical modifier. Preferably the crude chemical modifier comprises one or more free OH (hydroxyl) groups.

In a first aspect, the invention resides in a composition comprising a phenolic resin and crude glycerol.

Suitably, the composition is suitable for use in producing a phenolic resin product.

In a second aspect, the invention provides a method of producing a phenolic resin product including the step of adding crude glycerol to a phenolic resin to thereby produce the phenolic resin product.

In a third aspect the invention provides a phenolic resin product comprising a phenolic resin modified by adding crude glycerol.

According to the method of the second aspect and/or the product of the third aspect the phenolic resin product may be cured at a temperature between 70° C. and 90° C.

The curing may be at approximately 80° C.

According to the method of the second aspect and/or the product of the third aspect the phenolic resin product may be cured for between 4 and 8 hours.

The product may be cured for 6 hours.

According to the method of the second aspect and/or the product of the third aspect a catalyst may be used to catalyse curing.

The catalyst may be an acid catalyst.

According to the composition of the first aspect the composition may include an additional modifier.

According to the method of the second aspect the method may include adding an additional modifier.

According to the product of the third aspect the product may include an additional modifier.

The additional modifier may be selected from the group consisting of an isocyanate, polyvinyl alcohol, resorcinol, a polyol, a rubber particle, a polymer, a plant oil and a vegetable oil.

In a fourth aspect the invention provides a phenolic resin product produced by the method of the third aspect of the invention.

In a fifth aspect the invention provides an article comprising the phenolic resin product of the third or fourth aspects.

The article may have an improved physical property compared to a product comprising industrial grade glycerol.

The improved physical property may be strength and/or flexibility.

The article may be a moulded article.

The article may be a building material.

The article may be a marine composite.

The article may be an impregnated paper.

The article may be a sandpaper.

The building material may be a sandwich panel or floor panel.

In any of the above aspects the crude glycerol may be no more than 80% pure.

In any of the above aspects the crude glycerol may be 40 to 79.9% pure.

In any of the above aspects the crude glycerol may be 50 to 70% pure.

In any of the above aspects the crude glycerol may be the product of a reaction to produce biodiesel.

Further features of the present invention will become apparent from the following detailed description.

In this specification, the terms “comprises”, “comprising” or similar terms are intended to mean a non-exclusive inclusion, such that a method, system or apparatus that comprises a list of elements does not include those elements solely, but may well include other elements not listed.

### BRIEF DESCRIPTION OF THE DRAWINGS

In order that the present invention may be readily understood and put into practical effect, reference will now be made to the accompanying illustrations wherein:

FIG. 1 is a chart illustrating the step of one embodiment of the method of the invention;

FIG. 2 is a flowchart illustrating another embodiment of the method of the invention.

### DETAILED DESCRIPTION OF THE INVENTION

The invention relates, at least in part, to a phenolic resin product comprising a crude chemical modifier comprising one or more free OH (hydroxyl) groups. Examples of such chemical modifiers include glycerol and diols, such as, polypropylene glycol. Glycerol has three free OH groups and diols have two free OH groups. Therefore the chemical modifier may have two or more or three or more free OH groups.

The present inventors have advantageously found that adding crude glycerol to a phenolic resin significantly increases the physical properties of the resultant phenolic resin product. These physical properties are improved over and above those achieved or obtained when using industrial grade glycerol.

In addition to the improved properties attained by the present invention the utilization of crude glycerol has major economic benefits in using a relatively inexpensive source or form of glycerol rather than comparatively expensive industrial grade glycerol.

The phenolic resin composition and product of the invention may be used wherever conventional phenolic resins are used. Some non-limiting examples of where the phenolic resin product may be used are in civil engineering materials and building materials, in paper products and in marine composites. The phenolic resin product is particularly useful for producing a sandwich panel or a floor panel, as an adhesive in producing sandpaper and in impregnating paper products.

For ease of reference the present invention is described with reference to crude glycerol as produced by a base catalyzed transesterification reaction to produce biodiesel as the crude chemical modifier. It is appreciated that the invention may also use other crude chemical modifiers and other sources of crude glycerol, such as, for example, as formed as a by-product or product of an acid catalyzed transesterification reaction to produce biodiesel and/or soap manufacture (saponification of triglyceride oils).

“Crude glycerol” as used herein includes impure glycerol, for example crude glycerol having a purity less than about 80%. In one embodiment the crude glycerol has been partially purified, refined, treated and/or separated with a physical and/or mechanical separation process and has not been purified, refined, treated and/or separated with any chemical process to increase or improve purity. One example of this crude glycerol is produced in a transesterification reaction of a fat or oil and an alcohol and mechanically separated from the methylester produced in that reaction. The mechanical separation may be, for example, performed by centrifugation or settling in a settling tank.

Mechanical separation may also include adding one or more chemical reagents to the crude glycerol to facilitate the mechanical separation. An example of a suitable chemical reagent is an acid, base or other reagent which is added to precipitate and/or breakdown one or more of the contaminants in the crude glycerol. In another embodiment the crude glycerol may have been chemically separated, treated, purified and/or refined with a relatively inexpensive chemical separation process.

Examples of suitable inexpensive chemical separation processes include those that involve a gas second phase such as dehydration and/or evaporation. Examples of chemical separation processes that are not relatively inexpensive include vacuum distillation and/or ion exchange. Accordingly, “crude glycerol” also includes glycerol, that has been separated by a process that involves a gas second phase and does not use a vacuum and glycerol that has not been subjected to vacuum distillation and/or an ion exchange process.

A significant advantage of the present invention is that it is able to make use of crude glycerol produced as a by-product of biodiesel production. That is, the glycerol supplied from the biodiesel reaction can be used directly in the invention. For example, some biodiesel producers remove or partially remove the methanol from the glycerol by-product. As shown in the examples below, residual methanol does not negatively affect the present invention. Therefore both crude glycerol that has been purified or partially purified with a methanol removal step and crude glycerol that has not been treated with such a purification or partial purification is suitable for use in the invention.

Further highlighting the adaptability of the present invention, one or more of residual acid, free fatty acids and/or salts do not negatively affect the present invention. Therefore, the acidity of the crude glycerol does not have to be neutralized. Similarly, about two (2) to three (3) percent of free fatty acids and/or salts does not adversely affect the present invention.

Importantly, the crude glycerol used in the invention is not industrial grade glycerol which typically has a glycerol content of 80.0% or greater

By way of example only, crude glycerol according to the invention has a purity of 40 to 80%. The crude glycerol may also have a purity of 50 to 70%. In particular embodiments the crude glycerol may have a purity of 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79 or 80%.

It is to be understood that purified, refined, treated and separated are relative terms and any step that increases purity by any amount is considered a purification, refinement, treatment and/or separation.

In addition to crude glycerol the invention may make use of an additional modifier to further improve the properties attained with the invention. The additional modifiers are detailed below.

As mentioned above, one source of crude glycerol for use in the invention is as a product or by-product in the production of biodiesel from fat or oil and alcohol. Crude glycerol produced in this way comprises approximately 10-20% of the products of the biodiesel transesterification reaction, the rest is biodiesel. The crude glycerol generated in biodiesel production comprises several other components, including water, soap, alcohol (usually methanol), fatty acid, phosphoric acid and potassium or sodium hydroxide.

Following the transesterification reaction, crude glycerol is mechanically separated from the biodiesel. Due to the low solubility of glycerol in the esters, the mechanical separation generally occurs quickly and may be accomplished with, for example, a settling tank or a centrifuge.

Crude glycerol from this source typically contains excess alcohol (usually methanol) which tends to act as a solubilizer and can slow the mechanical separation. However, due to concern about reversing the transesterification reaction this excess alcohol is usually not removed from the reaction stream until after the glycerol and methyl esters are separated. Water may be added to the reaction mixture after the transesterification is complete to improve the separation of glycerol.

The crude glycerol stream leaving the separator is only about 10-15% glycerol. This crude glycerol stream may be orange-brown however, the colour depends on the fat source used in the transesterification reaction. The crude glycerol stream contains some of the excess alcohol and most of the catalyst and soap. In this form, chemically untreated biodiesel by-product crude glycerol conventionally has little commercial value. This is partly because the alcohol content requires it to be treated as hazardous waste, which complicates disposal. Due to this contamination the chemically untreated biodiesel by-product crude glycerol conventionally has limited value and is typically sold to a glycerol refiner for further refinement. The glycerol refining and purifying process typically uses expensive vacuum distillation or ion exchange processes which takes the purity up to 99.5 to 99.7%.

This highlights another advantage of the present invention, namely that the utilization of crude glycerol has major cost benefits in using relatively inexpensive glycerol rather than comparatively expensive industrial grade glycerol.

The biodiesel process is optimised to produce biodiesel. For this reason, there may be better ways to produce crude glycerol than through biodiesel production. A person of skill in the art is readily able to select other processes for producing crude glycerol.

One step in purifying chemically untreated biodiesel by-product crude glycerol produced by base catalyzed transesterification to give one form of crude glycerol is acidulation, in which acid is added to split any soap present into free fatty acids (FFAs) and salts. The free fatty acids are not soluble in glycerol and will rise to the top where they can be removed and recycled. Any salts present remain in the crude glycerol, although depending on the chemical compounds present, some may precipitate out.

Suitable acids for acidulation include, for example, phosphoric (orthophosphoric) and hydrochloric acid.

The acidulation purifies the crude glycerol product in two ways:

1) precipitation of excess potassium or sodium hydroxide as potassium or sodium phosphate salts; and

2) breakdown of soap into FFAs.

The phosphate salts formed and FFAs produced are readily removed by mechanical separation.

It is to be understood that acidulation need not make the crude glycerol acidic and merely includes adding an acid to the crude glycerol.

The acidulation step may also be used to purify a crude glycerol that is a by-product of acid catalysed transesterification. Acid catalysed transesterification is used when the fat or oil has a high FFA level to reduce these levels. After reduction of the FFA levels, a standard base catalysis process is used to create the biodiesel and crude glycerol.

After acidulation and mechanical separation of the FFAs, some or all of the alcohol in the acidulated crude glycerol may be removed by a relatively inexpensive chemical separation treatment. The alcohol removal step, may for example, be an evaporation step, such as, a vacuum flash process. A person of skill in the art is readily able to select an appropriate alcohol removal step, such as, for example, flash distillation.

In embodiments that use evaporative heating the acidulated crude glycerol may be heated to between 70 and 75° C. A person of skill in the art is readily able to select appropriate heating temperatures and times.

It is to be understood that the alcohol removal is relative and all alcohol need not be removed. A person of skill in the art is readily able to modify the alcohol removal step to effect a greater or lesser effective alcohol removal as desired.

The acidulation and alcohol removal produces one form of crude glycerol. It is understood and expected that this crude glycerol does not consist wholly of glycerol and water, and may contain small quantities of FFAs, methanol, soap, biodiesel and/or salts. In addition, it is expected that this product is acidic in nature, containing some excess acid.

After the acidulation and methanol removal the crude glycerol typically has a purity of approximately 50-70%. The remaining 50-30% consists of water, residual acid, fatty acids, residual soap and catalyst.

In one embodiment some of the water in the crude glycerol is removed in a relatively inexpensive chemical separation such as by for example a dehydration step. The dehydration may be achieved by evaporation, through gently boiling the crude glycerol. A person of skill in the art is readily able to select other methods for removing water such as incubation at temperatures lower than boiling. This embodiment is advantageous because it is known that large amounts of water in polymer resins may reduce the strength properties.

To produce the phenolic resin product of the invention the crude glycerol is added to a conventional phenolic resin. Suitable phenolic resins are for example phenolic resins, such as, J2027L (available from Hexion Chemicals Australia, Hexion Specialty Chemicals Australia Pty. 2-8 James Street, Layerton North, Victoria, Australia) and CL1916 (produced by Huntsman Chemical Australia, Somerville Road, PO Box 62, West Footscray Victoria, 3012, Australia).

The crude glycerol may be added to 100 parts per hundred (phr) resin in an amount of 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 parts per hundred weight. Preferably the crude glycerol is added in an amount between 20-30 phr to 100 phr resin giving a total of 120-130 parts.

As mentioned above, in addition to crude glycerol an additional modifier may be used to further increase the properties attained by the invention. The additional modifier may be added at the same time the crude glycerol and phenolic resin are mixed.

The additional modifier may be a chemical modifier or a non-reactive modifier.

Suitable chemical modifiers include isocyanate, polyvinyl alcohol, resorcinol, a polyol, a polymer, a plant oil and a vegetable oil.

If a polymer is used as the chemical modifier it is to be understood the polymer is a second polymer that is compatible with the phenolic resin and capable of being cured along with the resin. The second polymer may be cured along with the resin on-site.

Suitable plant and/or vegetable oils include linseed oil, soy bean oil and/or canola oil. Tests have shown good properties are achieved with these three oils.

Suitable non-reactive modifiers include a rubber particle.

The phenolic resin product may be polymerised by any suitable method such as, high temperature curing and/or catalysed curing.

In embodiments that use high temperature curing the resin is heated in an oven for a suitable period of time. A person of skill in the art is readily able to select suitable heating temperatures and periods.

Suitable catalysts for catalysed curing include, base and acid catalysts, for example, Phencat 15 (available from Hexion Chemicals Australia, see above).

After addition of the catalyst the resin formulations are cured. The curing may be performed at room temperature or may be accelerated by heating. It is understood that if the resin formulation is not heated it will continue to slowly cure over time until it is fully cured.

If accelerated curing by heating is used the resin formulation is allowed to cure at room temperature for 2-10 minutes before being post-cured in an oven for 2-8 hours.

A person of skill in the art is readily able to select suitable time durations and temperatures as well as other suitable curing processes and protocols.

In one embodiment the curing is performed at a temperature between 15° C.-40° C. for between 30 minutes and 2 hours, before being post-cured by heating in an oven at a constant temperature between 70° C. and 90° C. Preferably the curing is performed at room temperature and preferably for about one hour, before being post-cured by heating at 80° C. The formulations are heated to the desired temperature over a period of between 4 and 8 hours. Preferably the period is 6 hours. After heating the oven is ramped down to between 15° C. and 30° C. Preferably the oven is ramped down to 25° C. The ramping down is performed over a 10 to 60 minute period. Preferably the ramping down is performed over 30 minutes. After the oven has been ramped down to the desired temperature the cured resin product is removed from the oven.

The phenolic resin product comprising crude glycerol is characterised by lower viscosity, lower tackiness, lower levels of free formaldehyde and reduced hydrophobicity as compared to conventional resin.

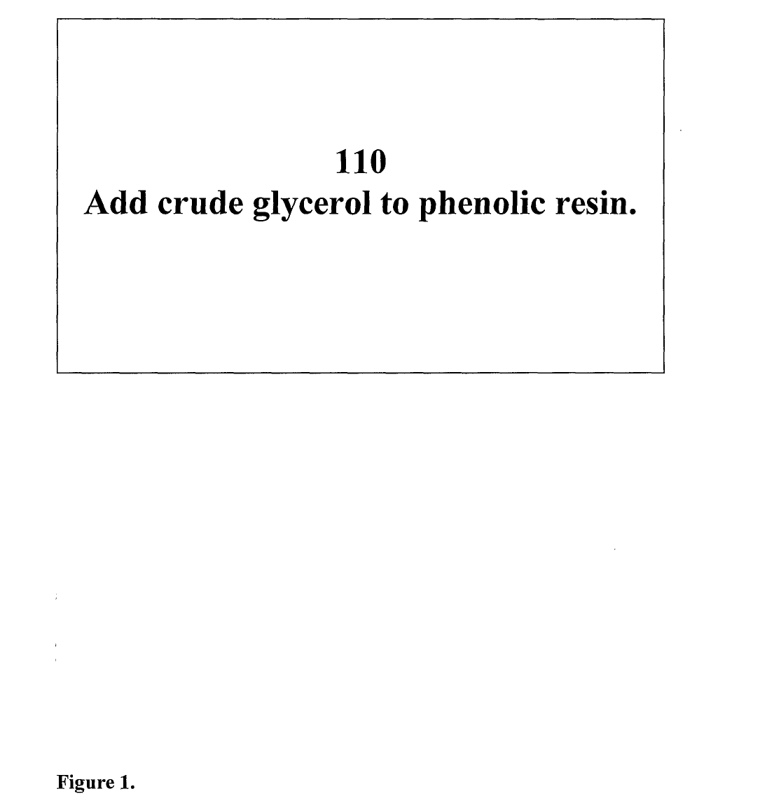

The invention also relates to a method for manufacturing a phenolic resin product. The method is illustrated in the chart of FIG. 1. In step 110 crude glycerol is added to a phenolic resin to form a phenolic resin product. The phenolic resin product may then be mixed.

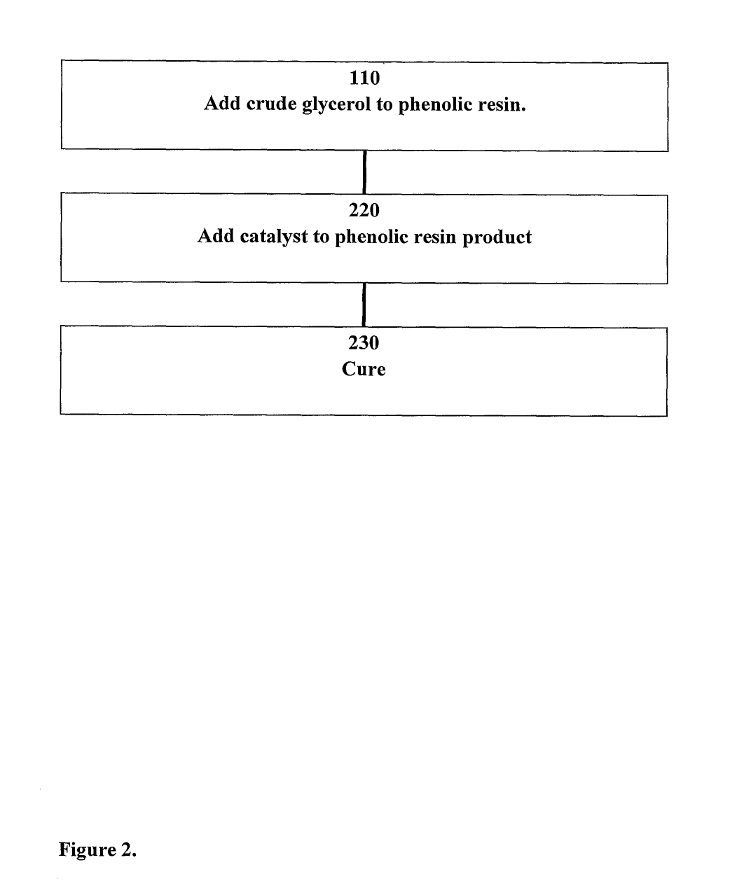

FIG. 2 shows a progression of the chart of FIG. 1, in which at step 220 a catalyst is added to the phenolic resin product to effect polymerization.

In step 230 the polymerized or partly polymerized phenolic resin product is cured. A person of skill in the art is readily able to select an appropriate curing method such as, for example, incubation at room temperature. In one embodiment the incubation is followed by heating and cooling.

The invention also provides a method of producing a building material including the step of adding crude glycerol to a phenolic resin to thereby produce the building material. Additionally, the invention provides a building material produced by the method.

Also provided is a method of modifying a phenolic resin including the step of adding crude glycerol to the phenolic resin to thereby modify the phenolic resin. Furthermore, a modified phenolic resin produced by the method is provided.

The crude glycerol may be added in a customised fashion by, for example, an end user on-site, at for example, a factory floor. Advantageously, the crude glycerol may also be added in a large scale production process, by for example, a chemical producer to manufacture an end product that is delivered to an end user. It is envisaged that slightly better properties may be achieved by adding the crude glycerol in a large scale process.

The flexibility in the point of adding the crude glycerol advantageously allows the production process to be adjusted to the volume and demand. That is, when the polymer resin product is in high demand it may be manufactured in a large scale production process. On the other hand, when the demand is less the polymer resin product may be manufactured by the end user.

The diligent study by the inventors has found that crude glycerol can be used as a very effective low cost chemical modifier for phenolic resin. In fact tests have shown that compared to conventional purified glycerol, chemical modification with crude glycerol results in a phenolic resin product with increased strength and flexibility.

While not wanting to be bound by any theory the inventors believe the crude glycerol has water and other remaining impurities in it including a residual acid which are responsible for the improved properties of the phenolic resin product. A further advantage of the invention is that because the crude glycerol contains some acid, less acid catalyst is required to be used to cure the phenolic resin.

Again while not wanting to be bound by any theory glycerol may affect phenolic resins because it has three OH (hydroxyl) groups in its structure and phenol (one of the base ingredients in phenolic resin) has one. Formaldehyde, the other component of phenolic resin, reacts with hydroxyl groups. Therefore, by adding glycerol to phenolics the glycerol may react in and become part of the polymeric network.

The beneficial results of the invention may also be obtained with a crude diol, which also have free OH groups, instead of crude glycerol. An example of such a diol is polypropylene glycol.

Again, while not wanting to be bound by any one theory the inventors hypothesize the acidity in the crude glycerol is at least partly responsible. It may be that the acidity assists with the incorporation of monomeric units into the polymeric network. Another hypothesis is that the remaining fatty acids lead to the improved properties.

So that the invention may be readily understood and put into practical effect, the following non-limiting Examples are provided

### EXAMPLES

### Example 1

### Production of Crude Glycerol

### First Method

Crude glycerol was obtained as a biodiesel reaction product of a base catalyzed transesterification reaction to produce biodiesel.

The obtained crude glycerol was acidulated by adding 5-10 parts per hundred weight of 75-85% orthophosphoric acid. The resulting solution was stirred thoroughly for 1-15 minutes.

The solid phosphate salts and low density FFAs (specific gravity (SG) ˜0.9) produced were mechanically separated from the glycerol/water/alcohol (SG˜1.2) mixture.

Methanol was then removed by moderate heating to between approximately 70-75° C.

### Second Method—Water Removal (Dehydration)

Crude glycerol was also prepared using a variation on the first method described above. In the process of the variation some of the water in the crude glycerol was boiled off by slightly boiling for approximately one hour.

### Example 2

### Manufacture of Phenolic Resin Product Using Crude Glycerol

J2027L resin and Phencat 15 acid catalyst were obtained from Hexion Chemicals Australia. As shown in Table 1 five formulations, A-E, were made.

The resin formulations were each formed into several samples which were left to cure at room temperature for about one hour.

The samples were placed in an oven and the temperature was ramped up to 80° C. over a 6 hr period and then kept constant at 80° C. for four hours.

The oven was then ramped down to 25° C. over a half hour period and the samples were removed from the oven.

### Example 3

### Comparative Tests and Results

Test specimens of the formulations A-E were cut with dimensions 4 mm×10 mm×80 mm. These specimens were tested at a speed of 2 mm/min according to ISO testing standard 178 “Plastics-Determination of Flexural Properties” to determine flexural strength, flexural modulus and failure strain.

The results of the tests are shown in Table 1. Specimens D and E, consisting of polymer resin product according to the invention, have improved flex strength and flexural strain compared to samples A-C which consist of conventional polymer resins.

The fire resistance of the polymer resin product is also very good. It is self-extinguishing and produces low levels of smoke which is essential for most applications.

Further, at levels of approximately 25-30% crude glycerol the heat distortion temperature (HDT) of the polymer resin product is still above 100° C. which is more than adequate for most civil engineering applications.

Both sample D comprising unboiled crude glycerol and sample E comprising boiled crude glycerol have improved properties over and above those of sample C comprising conventional industrial grade 99.5% pure glycerol. Because the unboiled crude glycerol has good properties it is not necessary to go through the boiling process which is another step in the production process and costs time and money. Also, if some of the water in the crude glycerol is removed it becomes very viscous and difficult to work with.

Similar improved results were obtained with samples produced using crude glycerol that had not been treated with a methanol removal step.

### Example 4

### Manufacture of Phenolic Resin Product Using Crude Glycerol

Crude glycerol was produced as described above. The crude glycerol was used to manufacture a phenolic resin product as described above with the addition of adding polyvinyl alcohol (PVA) at the time of adding the glycerol to resin and catalyst. As shown in Table 2 five formulations, F-J, were made. The resin formulations were each formed into several samples which were left to cure as described above. Test specimens of the formulations F-J were prepared and tested as described above. The results of the tests are shown in Table 2 which features.

As shown in Table 2 sample G which includes 0.5% PVA has an improved flexural strength over sample F which does not include PVA. Samples H-J which comprise increased amounts of PVA, 1.0, 1.5, and 2.0% respectively, also have an increased flexural strength over sample F but the flexural strength appears to decrease slightly from sample G to J. Table 2 also shows that adding PVA increases the % flexural strain at failure. However, in this case the % flexural strain at failure appears to increase as the amount of PVA increases.

Unlike flexural strength and flexural strain which increase upon addition, the flexural modulus decreased as the amount of added PVA increased.

One advantage of using crude glycerol is that it is generally four (4) to five (5) times cheaper than conventional purified glycerol. Acidulation and methanol removal are relatively inexpensive processes compared to other processes, such as, vacuum distillation and treatment used to produce purified glycerol.

Another advantage of the polymer resin product of the invention is that it is derived from renewable resources rather than petrochemicals. This highlights another benefit of the invention which is to partly overcome the dependence on fossil-fuel based polymers and modifiers. The inventors approach is environmentally beneficial and contributes towards sustainable production of polymer resin systems. Furthermore, the inventors have produced a phenolic resin product that is produced from plant oils and that does not suffer from the lower structural properties that has limited the use of prior art plant based polymers in civil and structural engineering composites.

Of significant advantage of the present invention is that it makes use of the crude glycerol that is being produced in large amounts by the biodiesel industry.

Further highlighting the advantage of the present invention is that good use of an abundant by-product is made in a way that avoids expensive purification techniques.

The environmentally sound nature of the invention is further advanced when potassium hydroxide is used as the transesterification reaction catalyst and phosphoric acid is used for acidulation. In such a case the salt formed will be potassium phosphate, which may be used as a fertilizer.

Another advantage of the invention is that the phenolic resin product has a high temperature behaviour that is suitable for use in civil and structural engineering composites.

Throughout the specification the aim has been to describe the preferred embodiments of the invention without limiting the invention to any one embodiment or specific collection of features. It will therefore be appreciated by those of skill in the art that, in light of the instant disclosure, various modifications and changes can be made in the particular embodiments exemplified without departing from the scope of the present invention.

All computer programs, algorithms, industrial, patent and scientific literature referred to herein is incorporated herein by reference.

TABLE 1
Improved properties of phenolic resin product comprising crude
glycerol

| | | Flexural Strain | Flexural |
|---|---|---|---|
| | Flex Strength | at Failure % | Modulus MPa |
| Formulation | MPa (SV) | (SV) | (SV) |
| A. 100 phr J2027L | 27.7 (8.6) | 0.94 (0.29) | 2934 (27) |
| 8 phr Phencat 15 | | | |
| B. 70 phr J2027L | 33.5 (3.5) | 3.7 (0.5) | 1063 (22) |
| 30 phr | | | |
| polypropylene | | | |
| glycol | | | |
| 8 phr Phencat 15 | | | |
| C. 70 phr J2027L | 37.9 (8.9) | 3.2 (0.9) | 1315 (89) |
| 30 phr Pure | | | |
| Glycerol | | | |
| 8 phr Phencat 15 | | | |
| D. 70 phr J2027L | 50.3 (3.6) | 3.8 (0.3) | 1496 (33) |
| 30 phr un-purified | | | |
| Biodiesel Glycerol | | | |
| 8 phr Phencat 15 | | | |
| E. 70 phr J2027L | 50.7 (3.3) | 4.7 (0.6) | 1321 (31) |
| 30 phr un-purified | | | |
| Biodiesel Glycerol, | | | |
| boiled | | | |
| 8 phr Phencat 15 | | | |

MPA = megapascals.
SV = standard variation.

TABLE 2
Improved properties of phenolic resin product comprising crude
glycerol and polyvinyl alcohol (PVA)

| | | | | | Flexural | Flexural | Flexural |
|---|---|---|---|---|---|---|---|
| | | | | | Strength | Strain at | Modulus |
| | | Biodiesel | | Phencat | MPa | Failure | MPa |
| | J2027L | Glycerol | PVA | 15 | (SV) | % (SV) | (SV) |
| F | 85 | 15.0 | — | 4.0 | 62.1 | 3.5 | 2029 |
| | | | | | (3.3) | (0.4) | (17) |
| G | 85 | 14.5 | 0.5 | 4.0 | 74.5 | 5.4 | 2019 |
| | | | | | (2.6) | (0.6) | (44) |
| H | 85 | 14.0 | 1.0 | 4.0 | 73.5 | 5.5 | 1949 |
| | | | | | (1.6) | (1.1) | (66) |
| I | 85 | 13.5 | 1.5 | 4.0 | 72.8 | 5.5 | 1940 |
| | | | | | (1.4) | (0.4) | (38) |
| J | 85 | 13.0 | 2.0 | 4.0 | 72.0 | 6.0 | 1904 |
| | | | | | (4.0) | (1.1) | (52) |

MPA = megapascals.
SV = standard variation.
All values in grams.

1. A composition comprising a phenolic resin and crude glycerol.

2. The composition of claim 1 wherein the composition is suitable for use in producing a phenolic resin product.

3. The composition of claim 1 wherein the crude glycerol is no more than 80% pure.

4. The composition of claim 1 wherein the crude glycerol has a purity of 40 to 80%.

5. The composition of claim 1 wherein the crude glycerol is 50 to 70% pure.

6. The composition of claim 1 wherein the crude glycerol is a product of a reaction to produce biodiesel.

7. The composition of claim 1 further comprising an additional modifier.

8. The composition of claim 7 wherein the additional modifier is selected from the group consisting of an isocyanate, polyvinyl alcohol, resorcinol, a polyol, a rubber particle, a polymer, a plant oil and a vegetable oil.

9. A method of producing a phenolic resin product including the step of adding crude glycerol to a phenolic resin to thereby produce the phenolic resin product.

10. The method of claim 9 wherein the crude glycerol is no more than 80% pure.

11. The method of claim 9 wherein the crude glycerol is 40 to 80% pure.

12. The method of claim 9 wherein the crude glycerol is 50 to 70% pure.

13. The method of claim 9 wherein the crude glycerol is a product of a reaction to produce biodiesel.

14. The method of claim 9 wherein the phenolic resin product is cured and at a temperature between 70° C. and 90° C.

15. The method of claim 9 wherein the phenolic resin product is cured at 80° C.

16. The method of claim 9 wherein the phenolic resin product is cured for between 4 and 8 hours.

17. The method of claim 9 wherein the phenolic resin product is cured for 6 hours.

18. The method of claim 9 further including the step of adding a catalyst to catalyse catalyze curing.

19. The method of claim 18 wherein the catalyst is an acid catalyst.

20. The method of claim 9 further including the step of adding an additional modifier.

21. The method of clam 20 wherein the additional modifier is selected from the group consisting of an isocyanate, polyvinyl alcohol, resorcinol, a polyol, a rubber particle, a polymer, a plant oil and a vegetable oil.

22. A phenolic resin product comprising a phenolic resin modified by adding crude glycerol.

23. The phenolic resin product of claim 22 wherein the crude glycerol is no more than 80% pure.

24. The phenolic resin product of claim 22 wherein the crude glycerol has a purity of 40 to 80%.

25. The phenolic resin product of claim 22 wherein the crude glycerol has a purity of 50 to 70%.

26. The phenolic resin product of claim 22 wherein the crude glycerol is a product of a reaction to produce biodiesel.

27. The phenolic resin product of claim 22 wherein the phenolic resin product is cured at a temperature between 70° C. and 90° C.

28. The phenolic resin product of claim 22 wherein the phenolic resin product is cured at 80° C.

29. The phenolic resin product of claim 22 wherein the phenolic resin product is cured for between 4 and 8 hours.

30. The phenolic resin product of claim 22 wherein the phenolic resin product is cured for 6 hours.

31. The phenolic resin product of claim 22 wherein the phenolic resin product is catalysed catalyzed by adding a catalyst.

32. The phenolic resin product of claim 31 wherein the catalyst is an acid catalyst.

33. The phenolic resin product of claim 22 further including an additional modifier.

34. The phenolic resin product of claim 33 wherein the additional modifier is selected from the group consisting of an isocyanate, polyvinyl alcohol, resorcinol, a polyol, a rubber particle, a polymer, a plant oil and a vegetable oil.

35. A phenolic resin product produced by the method of claim 9.

36. An article comprising the phenolic resin product of claim 22.

37. The article of claim 36 wherein the article has an improved physical property compared to a product comprising industrial grade glycerol.

38. The article of claim 37 wherein the improved physical property may be is selected from the group consisting of strength and flexibility.

39. The article of claim 36 wherein the article is selected from the group consisting of a molded article a building material a marine composite an impregnated paper, a sandpaper a sandwich panel and a floor panel.

40-44. (canceled)

45. An article comprising the phenolic resin product of claim 35.

46. The article of claim 45 wherein the article has an improved physical property compared to a product comprising industrial grade glycerol.

47. The article of claim 46 wherein the physical property is selected from the group consisting strength and flexibility.

48. The article of claim 45 wherein the article is selected from the group consisting of a molded article a building material a marine composite an impregnated paper, a sandwich panel and a floor panel.

49-53. (canceled)
